(19) United States
(12) Patent Application Publication
(10) Pub. No.: US 2026/0059310 A1
(43) Pub. Date: Feb. 26, 2026

(54) NETWORK SLICE OR TENANT SPECIFIC AUTOMATED CERTIFICATE MANAGEMENT CONFIGURATIONS

(71) Applicant: Nokia Technologies Oy, Espoo (FI)

(72) Inventors: German PEINADO GOMEZ, Wroclaw (PL); Jing PING, Chengdu (CN); Rakshesh PRAVINCHANDRA BHATT, Bangalore (IN)

(21) Appl. No.: 19/102,566

(22) PCT Filed: Aug. 16, 2022
(86) PCT No.: PCT/CN2022/112874

§ 371 Date: Feb. 10, 2025

(51) Int. Cl. H04W 12/069

(52) U.S. Cl. CPC H04W 12/069

(57) ABSTRACT

Example embodiments of the present disclosure relate to devices, methods, apparatuses and computer readable media supporting network slice or tenant specific automated certificate management configurations. A network slice certificate orchestrator may be configured to receive from a management system certification authority configuration indicative of a certification authority configured for one or more network slices, and transmit to a registration authority or a certification authority a certificate request with respect to a network function allocated to one of the one or more network slices along with information of the certification authority configured for the one or more network slices.

### TECHNICAL FIELD

Various exemplary embodiments described herein generally relate to communication technologies, and more particularly, to devices, methods, apparatuses and computer readable media supporting network slice or tenant specific automated certificate management configurations.

### BACKGROUND

5G New Radio (NR) is designed for various use cases including for example enhanced Mobile Broad Band (eMBB), massive Machine Type Communication (mMTC) and ultra Reliable and Low Latency Communication (uRLLC). The use cases may require different types of features and networks in terms of mobility, security, policy control, latency, coverage and reliability. Therefore, network slicing has been proposed to slice one physical network into multiple virtual end to end (E2E) networks to carry different types of communication services with different characteristics and requirements.

### SUMMARY

In general, example embodiments of the present disclosure provide a solution for network slice or tenant specific automated certificate management configurations.

In a first aspect, an example embodiment of a network slice certificate orchestrator is provided. The network slice certificate orchestrator may comprise at least one processor and at least one memory storing instructions. The instructions, when executed by the at least one processor, cause the network slice certificate orchestrator at least to receive from a management system, certification authority configuration indicative of a certification authority configured for one or more network slices, and transmit to a registration authority or a certification authority, a certificate request with respect to a network function allocated to one of the one or more network slices along with information of the certification authority configured for the one or more network slices.

In a second aspect, an example embodiment of a management system is provided. The management system may comprise at least one processor and at least one memory storing instructions. The instructions, when executed by the at least one processor, cause the management system at least to establish a secure connection with a network slice certificate orchestrator, and transmit to the network slice certificate orchestrator, certification authority configuration indicative of a certification authority configured for one or more network slices.

Example embodiments of methods, apparatuses, and computer readable media are also provided. Such example embodiments generally correspond to the above example embodiments of the devices, and a repetitive description thereof is omitted here for convenience.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 is a schematic block diagram illustrating network slices logically isolated from each other based on tenant.

FIG. 2 is a schematic message flowchart illustrating a process according to an example embodiment of the present disclosure.

FIG. 3 is a schematic block diagram illustrating a tenant specific root certification authority configuration for network slices belonging to a tenant according to example embodiment of the present disclosure.

FIG. 4 is a schematic block diagram illustrating a network slice specific root certification authority configuration according to example embodiment of the present disclosure.

FIG. 5 is a schematic block diagram illustrating a tenant specific sub-certification authority configuration for network slices belonging to a tenant according to example embodiment of the present disclosure.

FIG. 6 is a schematic block diagram illustrating a network slice specific sub-certification authority configuration according to example embodiment of the present disclosure.

FIG. 7 is a schematic block diagram illustrating an apparatus according to an example embodiment of the present disclosure.

FIG. 8 is a schematic block diagram illustrating an apparatus according to an example embodiment of the present disclosure.

FIG. 9 is a schematic block diagram illustrating a device according to an example embodiment of the present disclosure.

FIG. 10 is a schematic block diagram illustrating a device according to an example embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Network slicing is a functionality that facilitates lots of vertical users to create and manage logically separated resources across for example the 5G system (5GS), dedicated for their own applications, while ensuring the desired service level requirements are met always. A network slice can be understood as a logical network that operates on top of a physical network, and multiple network slices operating on the physical network may share network resources. A network slice may be logically isolated from other slices when for example a sensitive service is running on the network slice which needs to be isolated from other services.

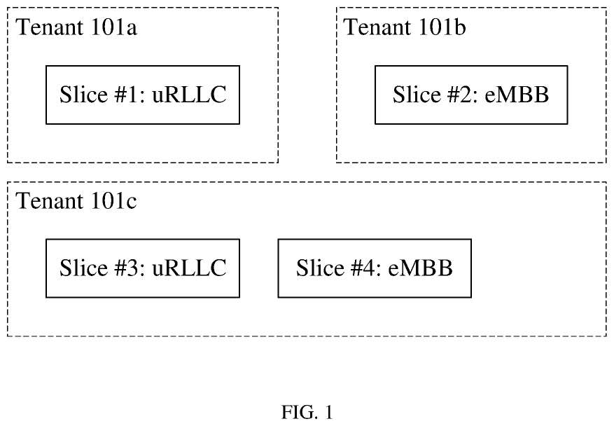

FIG. 1 illustrates a scenario where network slices are logically isolated based on tenant. Referring to FIG. 1, a first tenant 101a has a first slice (Slice #1) providing a uRLLC service, a second tenant 101b has a second slice (Slice #2) providing an eMBB service, and a third tenant 101c has a third slice (Slice #3) providing a uRLLC service and a fourth slice (Slice #4) providing an eMBB service. The network slices #1 to #4 may be hosted in the same operator's data centre. In the tenant based isolation scenario, the network slice #1 owned by the first tenant 101a, the network slice #2 owned by the second tenant 101b, and the network slices #3, #4 owned by the third tenant 101c are logically isolated, as shown by the dashed-line boxes in FIG. 1. Since network slicing spans across the access network (AN), the transport network (TN) and the core network (CN), slice isolation is also ensured in each of the AN domain, the TN domain and the CN domain.

It would be appreciated that the network slices may also be isolated in other ways. For example, the network slices may be isolated based on slice service type (SST). Referring to FIG. 1, the network slices #1, #3 providing the uRLLC services may be isolated from the network slices #2, #4 providing the eMBB services.

Digital certificates are used to establish authenticated and encrypted connections between various network functions (NFs), and careful management is required for the lifecycle of the digital certificates. For example, a digital certificate may need renewal and update for various reasons. In order to ensure well management of the digital certificates, automated certificate management may be implemented. Different network slices and tenants may have different requirements for automated certificate management, and different certificate authorities (CAs) may be used for different tenants and/or different network slices. It is desirable that the automated certificate management may be flexibly configured for the slices and tenants. The network operators may also want to have flexible business model offering with regard to slice or tenant specific automated certificate management.

On the other hand, if an automated certificate management implementation has potential loop-holes, it can cause security risks and adversely impact the services provided to the vertical users. For example, if automated certificate update does not complete before the expiry date, it can lead to slice/service un-availability, which needs manual administration of the certificates. Vertical users of network slices hosted in the same operator's data centre may want to ensure that any compromised/malfunctioning automated certificate management from the operator would not impact security of their own business. Vertical users may also want to use their trusted CA for all or part of the slice-specific services.

However, current 3GPP specifications do not support flexible automated certificate management configurations. Vertical users are not allowed to use slice-specific or tenant-specific automated certificate management services to protect their services. The vertical users have to rely on operator-provided automated certificate management services, including operator's CAs, operator's automations, etc. This also incurs additional cost for the vertical users.

According to aspects of the present disclosure, a mechanism for flexible automated certificate management configurations is proposed. In some example embodiments, network slice certificate orchestrator (NSCO) can provide interfaces towards an authorized third party, who can be owning one or more network slices, in order to allow flexible configurations for the automated certificate management services. The third party can configure his own root CAs or subordinate CAs to manage certificates used by network functions allocated to specific slices owned by the third party.

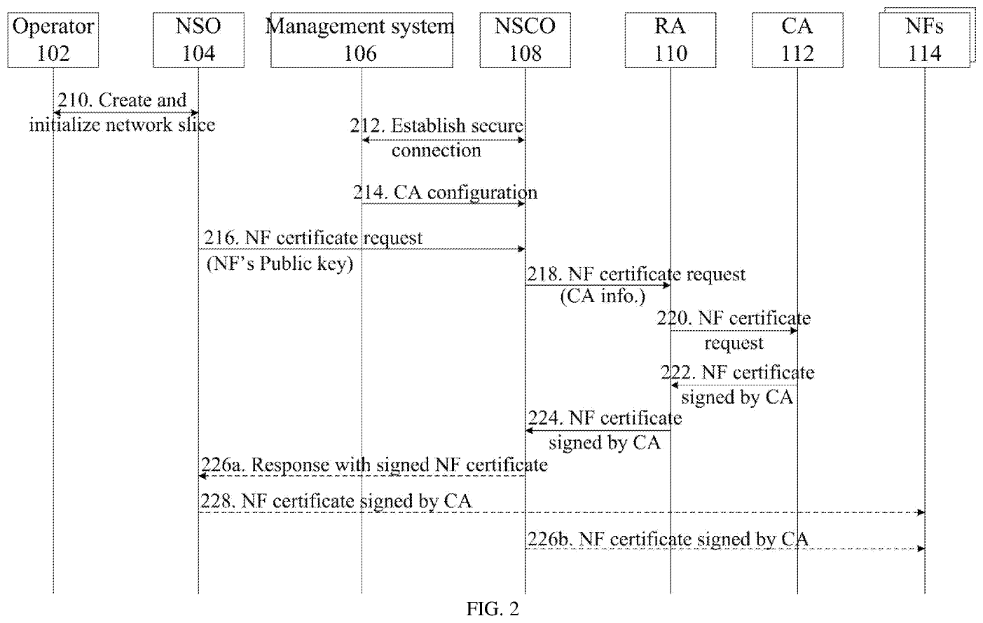

FIG. 2 illustrates a process for automated certificate management configuration according to an example embodiment of the present disclosure. Referring to FIG. 2, an operator 102, a network slice orchestrator (NSO) 104, a management system 106, a network slice certificate orchestrator (NSCO) 108, a registration authority (RA) 110, a certification authority (CA) 112 and network functions (NFs) 114 are shown as example entities involved in the process. It would be appreciated that operations performed by the operator 102 may be performed by the operator 102 using a relevant network function, e.g., a network slice management function (NSMF).

As shown in FIG. 2, at 210, the operator 102 may coordinate with the network slice orchestrator 104 to create and initialize a new network slice for a third party vertical user, i.e., a tenant. The operator 102 may create the network slice based on a service level agreement (SLA) or a service profile that specifies requirements such as bandwidth, rate, latency, connectivity and the like for the service to be run on the network slice. The network slice orchestrator 104 may take care of network function initialization and registrations, logical resource allocations across the core network (CN) domain, the transport network (TN) domain and the access network (AN) domain. Although not shown, additional logical functions such as a network slice instance (NSS) management function, a network slice resource module function, an NSS inventory function, a network slice data collection and analytics function or the like may also be used in creating and initializing the new network slice. In an example, one or more of the network slice orchestrator 104 and the additional logical functions may be included as a part in a network slice management function (NSMF), and the operator 102 can operate the NSMF to create and initialize the network slice for the tenant. The created network slice may have single-network slice selection assistance information (S-NSSAI) that uniquely identifies the network slice.

At 212, the management system 106 may establish a secure connection with the network slice certificate orchestrator (NSCO) 108 for exchanging certification authority (CA) configuration related information. For example, the management system 106 may establish a mutual transport layer security (mTLS) connection with the NSCO 108. The management system 106 may be a third party management system such as a certificate administration server owned or entrusted by the tenant authorized by the operator 102, and the NSCO 108 provides interfaces towards the certificate administration server. The operator 102 allows the tenant to configure his own automated certificate management services using the third party certificate administration server. In another example, the management system 106 may be provided by the operator 102 to support flexible automated certificate management configurations. For example, the management system 106 may be implemented as a part of an operation administration and maintenance (OAM) entity.

At 214, the management system 106 may transmit CA configuration (i.e., automated certificate management configuration) to the NSCO 108. With the CA configuration, the management system 106 can configure a root CA or a subordinate CA (sub-CA) to manage certificates in one or more network slices. In an example, details of the CA configuration may include one or more of:
a list of one or more network slices to which the CA configuration is applicable;
an internet protocol (IP) address or uniform resource locator (URL) of a CA configured for the one or more network slices;
information of a domain name system (DNS) server configured to resolve the URL of the CA; or
usage of the CA.
   The list of one or more network slices may include for example an S-NSSAI(s) of the one or more network slices. In another example, the list of one or more network slices may be represented by an identifier of the tenant, which means the configured CA is applicable to all network slices owned by the tenant. The information of the DNS server may include for example an IP address of the DNS server. The usage of the CA may indicate whether the configured CA is used as a root CA or a subordinate CA (sub-CA) for certificates in the one or more network slices. If the configured CA is a subordinate CA, in an example, the usage field may provide information of a hierarchy CA structure including the subordinate CA and one or more higher level CAs.

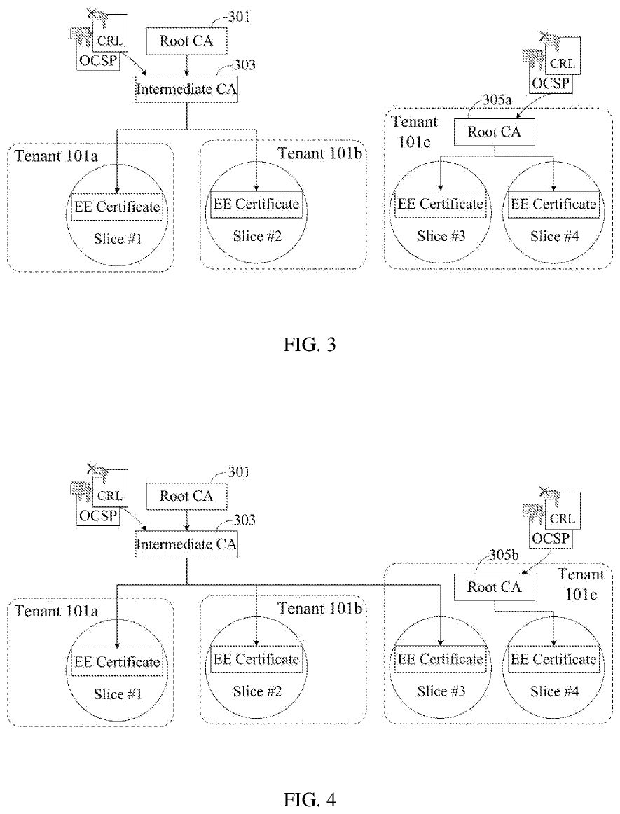

FIGS. 3-6 illustrate some example scenarios of the CA configurations. By way of example, FIGS. 3-6 show a first tenant 101a has a first network slice (Slice #1), a second tenant 101b has a second network slice (Slice #2), and a third tenant 101c has third and fourth network slices (Slices #3, #4). The network slices #1 to #4 each have one or more end entity (EE) certificates installed on end entities like network functions allocated to the respective network slices. In the example scenarios, by using the CA configuration transmitted to the NSCO 108 at 214, one or more network slices owned by the third tenant 101c may be flexibly configured with a root CA or a subordinate CA (sub-CA) for automated certificate management.

Referring to FIG. 3 first, there is shown a tenant specific root CA 305a configured for the third tenant 101c, i.e., for the network slices #3, #4 owned by the third tenant 101c. The root CA 305a would then be used to sign and manage certificates used by network functions allocated to the network slices #3, #4 belonging to the third tenant 101c. The root CA 305a can issue a certificate revocation list (CRL) or run an online certificate status protocol (OCSP) service for end entity (EE) certificates validation check. The end entity may also check with the CRL or the OCSP service for validation of root/sub-CA certificate.

In an example embodiment, the root CA 305a may be owned by the third tenant 101c. The third tenant 101c can configure his own automated certificate management service for network slices owned by the third tenant 101c. Other network slices belonging to other tenants (i.e., the first tenant 101a and the second tenant 101b in the example shown in FIG. 3) can use the operator's CA(s) for automated certificate management. FIG. 3 shows an intermediate CA 303 under a root CA 301, which both may be provided by the operator, for automated certificate management of certificates in the slice #1 and the slice #2. An intermediate CA, sometimes also referred to as a subordinate CA, is disposed between a root CA and end entity certificates and its main purpose is to define and authorize the types of certificates that can be requested from the root CA. For example, different intermediate CAs may be provided for different locations or different certificate types. There may be more than one intermediate CA level between the root CA and the end entity certificates in a CA hierarchy, and the CA hierarchy creates a chain of trust that the end entity certificates rely upon. Each end entity is signed by an intermediate CA above it, and the intermediate CA is signed by a higher level intermediate CA or a root CA. The root CA is at the highest level of the CA hierarchy and serves as the trust anchor which signs all intermediate CAs immediately below it. FIG. 3 shows one intermediate CA 303 between the root CA 301 and the end entity certificates. Similar to the root CA 305a, the intermediate CA 303 and the root CA 301 each can also issue a CRL or run an OCSP service for certificate validation check.

In another example embodiment, the root CA 301, the intermediate CA 303 and the root CA 305a all may be provided by the network operator. For example, the root CA 305a is provided for network slices of a particular tenant, while the intermediate CA 303 and the root CA 301 are provided for other tenants. In this regard, the root CA 305a may be referred to as a dedicated CA, and the intermediate CA 303 and the root CA 301 may be referred to as common CAs. The operator can provide flexible CA configurations and automated certificate management services to specific tenants.

FIG. 4 shows a slice specific root CA configuration scenario where a root CA 305b is configured for the fourth slice #4 of the third tenant 101c. The other slice #3 of the third tenant 101c, the network slice #1 of the first tenant 101a and the network slice #2 of the second tenant 101b may use the intermediate CA 303 under the root CA 301. In an example, the root CA 305b may be owned by the third tenant 101c. The third tenant 101c can configure his own automated certificate management service for a certain network slice owned by the third tenant 101c, while other network slices owned by the third tenant 101c can still use the automated certificate management service provided by the operator. In another example, the root CA 301, the intermediate CA 303 and the root CA 305b all may be provided by the operator. The operator can provide flexible CA configurations and automated certificate management services to specific network slices. Other aspects of the scenario shown in FIG. 4 is similar to the scenario shown in FIG. 3 and a repetitive description thereof is omitted here for convenience.

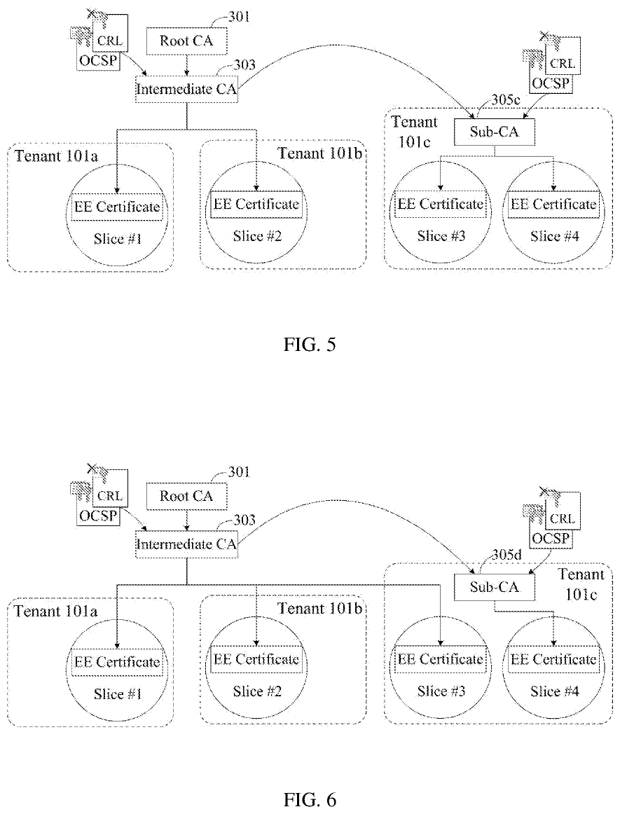

FIG. 5 illustrates a tenant specific subordinate CA (sub-CA) configuration scenario where a sub-CA 305c is configured for all network slices (i.e., the third slice #3 and the fourth slice #4) owned by the third tenant 101c. The sub-CA 305c may be signed by another intermediate or root CA. In the example shown in FIG. 5, the sub-CA 305c is signed by the intermediate CA 303, and the intermediate CA 303 is signed by the root CA 301. In an example, the sub-CA 305c may be owned by the third tenant 101c. The automated certificate management, including expiry and revocation handling, for the sub-CA 305c as well as the network slices owned by the third tenant 101c can be configured by the third tenant 101c. Alternatively, the sub-CA 305c may be managed by an authorized administration or intelligent function provided by the operator based on service level agreement (SLA) signed between the operator and the third tenant 101c. In another example embodiment, the sub-CA 305c, the intermediate CA 303 and the root CA 301 all may be provided by the operator. The operator can provide flexible CA configurations and automated certificate management services to specific tenants. Other aspects of the scenario shown in FIG. 5 is similar to the scenario shown in FIG. 3 and a repetitive description thereof is omitted here for convenience.

FIG. 6 illustrates a slice specific subordinate CA (sub-CA) configuration scenario where a sub-CA 305d is configured for the fourth slice #4 of the third tenant 101c. Similar to the tenant specific sub-CA 305c in FIG. 5, the slice specific sub-CA 305d may also be signed by the intermediate CA 303. In an example, the sub-CA 305d may be owned by the third tenant 101c. The automated certificate management, including expiry and revocation handling, for the sub-CA 305d as well as the network slice #4 can be configured by the third tenant 101c. Alternatively, the sub-CA 305d may be managed by an authorized administration or intelligent function provided by the operator based on service level agreement (SLA) signed between the operator and the third tenant 101c. In another example embodiment, the sub-CA 305d, the intermediate CA 303 and the root CA 301 all may be provided by the operator. The operator can provide flexible CA configurations and automated certificate management services to specific network slices. Other aspects of the scenario shown in FIG. 6 is similar to the scenario shown in FIG. 5 and a repetitive description thereof is omitted here for convenience.

Referring back to FIG. 2, with the CA configuration transmitted from the management system 106 to the NSCO 108 at 214, the management system 106 can configure a root CA or a sub-CA for specific network slices or specific tenants. Then the configured root CA or sub-CA can provide automated certificate management services, including for example certificate signing, revocation, renewal, update, etc., to the specific network slices or specific tenants (i.e., all network slices owned by the tenant). Hereinafter a new certificate signing process will be discussed as an example.

At 216, the network slice orchestrator 104 may transmit a network function (NF) certificate request to the NSCO 108. In an example embodiment, the NF certificate request may also be transmitted from other management systems such as a network slice management function (NSMF) or an operation administration and maintenance (OAM) entity to the NSCO 108. The request may include identity information of a NF, identity information of a network slice to which the NF belongs, and a public key of the NF to be signed. The identity information of the NF may include for example an IP address, an URL or an identifier of the NF, and the identity information of the network slice may include for example single-network slice selection assistance information (S-NSSAI) of the network slice. In an example, the request may further include information such as key type and length of the public key to be signed.

In response to the NF certificate request, the NSCO 108 may determine a certification authority (CA) for the network slice including the NF according to the S-NSSAI included in the NF certificate request and send the NF certificate request along with information of the determined CA to a registration authority (RA) 110 at 218. Here it is assumed that trust is pre-established between the NSCO 108 and the RA 110. The information of the CA may include for example an IP address or URL of the CA. In an example, the information of the CA may further include information of a DNS server to resolve the URL of the CA.

At 220, the RA 110 may forward the NF certificate request to a CA 112 that is indicated in the received CA information. The RA 110 may have pre-established trust with the CA 112, and based on the CA information, the RA 110 can transmit the NF certificate request to the appropriate CA 112. In an example embodiment, the RA 110 may check whether the NSCO 108 has the right to request the certificate of the network function before the RA 110 forward the NF certificate request to the CA 112. In an example embodiment, the RA 110 may be integrated in the CA 112, and it is commonly referred to as CA/RA. Then the NSCO 108 may transmit the NF certificate request to the CA 112. The CA 112 receives the NF certificate request and signs the public key of the network function, generating a signed digital certificate for the network function.

At 222, the CA 112 may respond to the RA 110 with the signed certificate for the network function. If the CA 112 is a root CA, the certificate signed by the root CA 112 would be sufficient. If the CA 112 is a sub-CA, the sub-CA 112 may further transmit, in addition to the NF certificate signed by the sub-CA 112, a trust chain from the sub-CA 112 to a root CA associated with the sub-CA 112 to the RA 110. The trust chain may include a chain of certificates of the sub-CA 112 and one or more higher level intermediate CAs (if exist). Each certificate in the trust chain is signed by an associated higher level CA, and eventually the highest level certificate is signed by the root CA associated with the sub-CA 112. For example, in the scenario shown in FIG. 5 or 6 where the sub-CA 305d signs a certificate for a network function, the sub-CA 305d would transmit a certificate of the sub-CA 305d signed by the intermediate CA 303 and a certificate of the intermediate CA 303 signed by the root CA 301 along with the NF certificate signed by the sub-CA 305d to the RA 110.

At 224, the NSCO 108 may receive from the RA 110 the certificate for the NF signed by the CA 112. If the CA 112 is a root CA, the NSCO 108 may also receive from the RA 110 the trust chain from the sub-CA 112 to the root CA associated with the sub-CA 112.

In the example embodiment where the RA 110 is integrated in the CA 112 and the NSCO 108 transmits the NF certificate request to the CA 112 as mentioned above, the NSCO 108 may transmit the signed certificate for the NF and the trust chain from the CA 112.

Then the NSCO 108 may send the certificate for the NF signed by the CA 112, as well as the trust chain if it exists, to a corresponding NF 114. In an example, the NSCO 108 may send the signed NF certificate to the NSO 104 or other management systems such as NSMF or OAM entities at 226a, and then the NSO 104 or the other management systems may send the signed NF certificate to the NF 114 at 228. In another example, the NSCO 108 may send the signed NF certificate directly to the NF 114 at 226b. The NSCO 108 may also send a copy of the signed NF certificate to the NSO 104 but the NSO 104 does not need to forward the signed NF certificate to the NF 114.

In the example embodiments discussed above with reference to FIGS. 2-6, flexible CA and automated certificate management services can be configured for specific network slices or specific tenants. By the network slice certificate orchestrator (NSCO) providing interfaces towards a management system owned by the operator or a third party, the management system is allowed to configure root or subordinate CAs for specific slices or specific tenants. It facilitates the operator or the third party who owns the management system to configure flexible CA and automated certificate management services for specific slices.

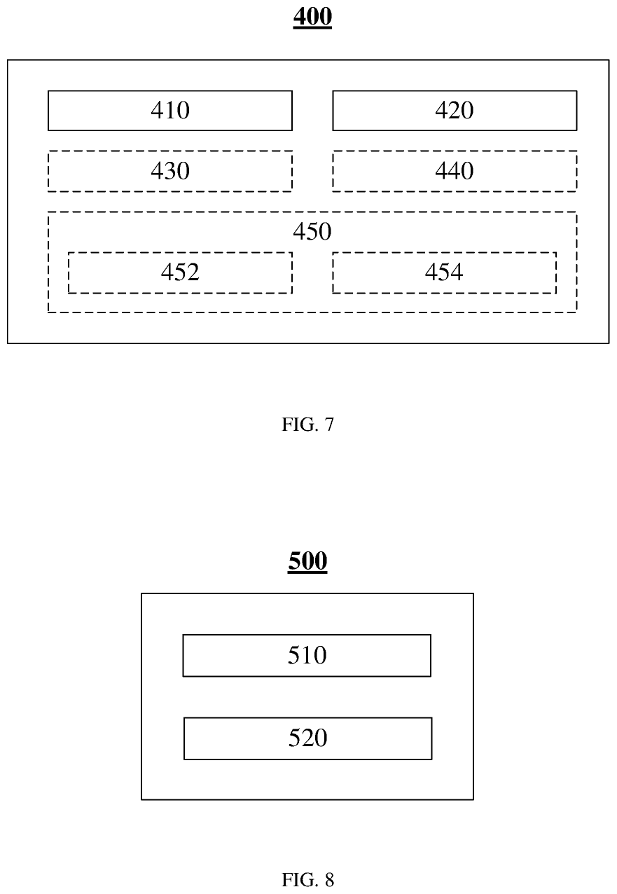

FIG. 7 is a schematic block diagram illustrating an apparatus 400 according to an example embodiment of the present disclosure. The apparatus 400 may be implemented to comprise or to form at least a part of a network slice certificate orchestrator (NSCO) like the NSCO 108 discussed above to perform operations related to the NSCO 108. Since the operations related to the NSCO 108 have been discussed in detail with reference to FIGS. 1-6, the blocks of the apparatus 400 will be described briefly here and details thereof may refer to the above description.

Referring to FIG. 7, the apparatus 400 may include a first means 410 for receiving from a management system such as a certificate administration server owned by a third party or an OAM entity owned by the operator, certification authority configuration indicative of a certification authority configured for one or more network slices, and a second means 420 for transmitting to a registration authority or a certification authority, a certificate request with respect to a network function allocated to one of the one or more network slices along with information of the certification authority configured for the one or more network slices.

In an example embodiment, the certification authority configuration may include at least one of a list of the one or more network slices, an internet protocol address or uniform resource locator of the certification authority configured for the one or more network slices, information of a domain name system server configured to resolve the uniform resource locator of the certification authority, or usage of the certification authority. For example, the usage of the certification authority may indicate whether the certification authority is a root certification authority or a subordinate certification authority for the one or more network slices.

In an example embodiment, the apparatus 400 may further include a third means 430 for receiving the certificate request with respect to the network function from a network slice orchestrator or other management systems like a network slice management function or an operation administration and maintenance entity. Then the second means 420 may transmit the certificate request to the registration authority.

In an example embodiment, the information of the certification authority transmitted to the registration authority may include at least one of an internet protocol address or uniform resource locator of the certification authority, or information of a domain name system server configured to resolve the uniform resource locator of the certification authority.

In an example embodiment, the apparatus 400 may further include a fourth means 440 for receiving from the registration authority or the certification authority a certificate for the network function signed by the certification authority configured for the one or more network slices, and a fifth means 450 for sending the signed certificate to the network function.

In an example embodiment, the certification authority is a subordinate certification authority configured for the one or more network slices, and the fourth means 440 further receives from the registration authority or the subordinate certificate authority, in addition to the certificate for the network function signed by the subordinate certification authority, a trust chain from the subordinate certification authority to a root certification authority associated with the subordinate certification authority. The trust chain may include a chain of certificates eventually signed by the root certification authority. The fifth means 450 may transmit the trust chain along with the certificate for the network function signed by the subordinate certification authority to the network function.

In an example embodiment, the fifth means 450 may include a first sub-means 452 for sending the signed certificate directly to the network function, or a second sub-means 454 for sending the signed certificate to the network slice orchestrator or the other management systems like the network slice management function or the operation administration and maintenance entity. Then the network slice orchestrator or the other management systems may forward the signed certificate to the network function.

It would be appreciated that the apparatus 400 may further include additional means for performing operations related to the NSCO 108 as discussed above.

FIG. 8 is a schematic block diagram illustrating an apparatus 500 according to an example embodiment of the present disclosure. The apparatus 500 may be implemented to comprise or to form at least a part of a management system like the management system 106 discussed above to perform operations related to the management system 106. Since the operations related to the management system 106 have been discussed in detail with reference to FIGS. 1-6, the blocks of the apparatus 500 will be described briefly here and details thereof may refer to the above description.

Referring to FIG. 8, the apparatus 500 may include a first means 510 for establishing a secure connection with a network slice certificate orchestrator, and a second means 520 for transmitting to the network slice certificate orchestrator certification authority configuration indicative of a certification authority configured for one or more network slices.

In an example embodiment, the certification authority configuration may include at least one of a list of the one or more network slices, an internet protocol address or uniform resource locator of the certification authority configured for the one or more network slices, information of a domain name system server configured to resolve the uniform resource locator of the certification authority, or usage of the certification authority. For example, the usage of the certification authority may indicate whether the certification authority is a root certification authority or a subordinate certification authority for the one or more network slices.

It would be appreciated that the apparatus 500 may further include additional means for performing operations related to the management system 106 as discussed above.

In an example embodiment, the means shown in FIGS. 7-8 may include circuitries configured to perform relevant operations. The term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a terminal device, a network device or a network function, to perform various functions, and
(c) hardware circuit(s) and/or processor(s), such as a microprocessor(s) or a portion of a microprocessor(s), that requires software (e.g., firmware) for operation, but the software may not be present when it is not needed for operation.

The above definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

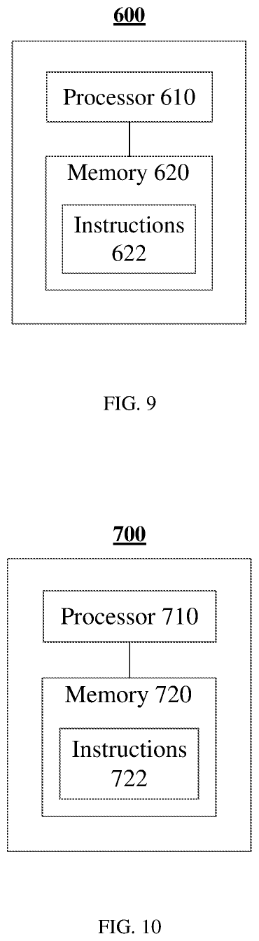

FIG. 9 is a schematic block diagram illustrating a device 600 according to an example embodiment of the present disclosure. The device 600 may be implemented as the network slice certificate orchestrator 108 discussed above.

Referring to FIG. 9, the device 600 may include one or more processors 610 and one or more memories 620. The one or more memories 620 may include instructions 622 stored thereon which, when executed by the one or more processors 610, may cause the device 600 to perform operations relating to the network slice certificate orchestrator 108 as described above.

FIG. 10 is a schematic block diagram illustrating a device 700 according to an example embodiment of the present disclosure. The device 700 may be implemented as the management system 106 discussed above.

Referring to FIG. 10, the device 700 may include one or more processors 710 and one or more memories 720. The one or more memories 720 may include instructions 722 stored thereon which, when executed by the one or more processors 710, may cause the device 700 to perform operations relating to the management system 106 as described above.

The processors 610, 710 may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The processors 610, 710 may be configured to control other elements of the devices 600, 700 respectively and operate in cooperation with them to perform the procedures discussed above.

The memories 620, 720 may include at least one storage medium in various forms, such as a volatile medium and/or a non-volatile medium. The volatile memory may include but not limited to for example a random access memory (RAM) or a cache. The non-volatile memory may include but not limited to for example a read only memory (ROM), a hard disk, a flash memory, and the like. Further, the memories 620, 720 may include but not limited to an electric, a magnetic, an optical, an electromagnetic, an infrared, or a semiconductor system, apparatus, or device or any combination of the above.

Some exemplary embodiments further provide computer program code or instructions which, when executed by one or more processors, may cause a device or apparatus to perform the procedures described above. The computer program code or instructions for carrying out procedures of the exemplary embodiments may be written in any combination of one or more programming languages. The computer program code or instructions may be provided to one or more processors or controllers of a general purpose computer, special purpose computer, or other programmable data processing apparatus, such that the program code or instructions, when executed by the processor or controller, cause the functions/operations specified in the flowcharts and/or block diagrams to be implemented. The program code or instructions may be executed entirely on a machine, partly on the machine, as a stand-alone software package, partly on the machine and partly on a remote machine or entirely on the remote machine or server.

Some exemplary embodiments further provide a non-transitory computer program product or a non-transitory computer readable medium having the computer program code or instructions stored therein. The term “non-transitory” as used herein is a limitation of the medium itself (i.e., tangible, not a signal) as opposed to a limitation on data storage persistency (e.g., RAM vs. ROM). The non-transitory computer readable medium may be any tangible medium that may contain or store a program for use by or in connection with an instruction execution system, apparatus, or device. The computer readable medium may be a computer readable signal medium or a computer readable storage medium. A computer readable medium may include but is not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It would be understood that blocks in the drawings may be implemented in various manners, including software, hardware, firmware, or any combination thereof. In some embodiments, one or more blocks may be implemented using software and/or firmware, for example, machine-executable instructions stored in the storage medium. In addition to or instead of machine-executable instructions, parts or all of the blocks in the drawings may be implemented, at least in part, by one or more hardware logic components. For example, and without limitation, illustrative types of hardware logic components that can be used include Field-Programmable Gate Arrays (FPGAs), Application-Specific Integrated Circuits (ASICs), Application-Specific Standard Products (ASSPs), System-on-Chip systems (SOCs), Complex Programmable Logic Devices (CPLDs), etc.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the subject matter has been described in a language that is specific to structural features and/or method actions, it is to be understood the subject matter defined in the appended claims is not limited to the specific features or actions described above. On the contrary, the above-described specific features and actions are disclosed as an example of implementing the claims.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Certain abbreviations that may be found in the description and the figures are herewith defined as follows:

| | |
|---|---|
| 3GPP | 3rd Generation Partnership Project |
| 5G | 5th Generation Wireless Technology |
| AN | Access Network |
| CA | Certification Authority |
| CN | Core Network |
| CRL | Certificate Revocation List |
| DNS | Domain Name System |
| NF | Network Function |
| NSCO | Network Slice Certificate Orchestrator |
| NSMF | Network Slice Management Function |
| OAM | Operation Administration and Maintenance |
| OCSP | Online Certificate Status Protocol |
| RA | Registration Authority |
| S-NSSAI | Single-Network Slice Selection Assistance Information |
| TN | Transport Network |
| URL | Uniform Resource Locator |

1-32. (canceled)

33. A network slice certificate orchestrator comprising:
at least one processor; and
at least one memory storing instructions that, when executed by the at least one processor, cause the network slice certificate orchestrator at least to:
receive from a management system, certification authority configuration indicative of a certification authority configured for one or more network slices; and
transmit to a registration authority or a certification authority, a certificate request with respect to a network function allocated to one of the one or more network slices along with information of the certification authority configured for the one or more network slices.

34. The network slice certificate orchestrator of claim 33, wherein the certification authority configuration comprises at least one of:
a list of the one or more network slices;
an internet protocol address or uniform resource locator of the certification authority configured for the one or more network slices;
information of a domain name system server configured to resolve the uniform resource locator of the certification authority; or
usage of the certification authority.

35. The network slice certificate orchestrator of claim 34, wherein the usage of the certification authority indicates whether the certification authority is a root certification authority or a subordinate certification authority for the one or more network slices.

36. The network slice certificate orchestrator of claim 33, wherein the certificate request with respect to the network function is received from a network slice orchestrator.

37. The network slice certificate orchestrator of claim 33, wherein the at least one memory further stores instructions that, when executed by the at least one processor, cause the network slice certificate orchestrator at least to:
receive from the registration authority or the certification authority, a certificate for the network function signed by the certification authority configured for the one or more network slices; and
send the signed certificate to the network function.

38. The network slice certificate orchestrator of claim 37, wherein in a case where the certification authority is a subordinate certification authority configured for the one or more network slices, the network slice certificate orchestrator further receives from the registration authority or the subordinate certification authority, in addition to the certificate for the network function signed by the subordinate certification authority, a trust chain from the subordinate certification authority to a root certification authority associated with the subordinate certification authority, and the trust chain is transmitted along with the certificate for the network function signed by the subordinate certification authority to the network function.

39. The network slice certificate orchestrator of claim 38, wherein the trust chain comprises a chain of certificates eventually signed by the root certification authority.

40. The network slice certificate orchestrator of claim 37, wherein the signed certificate is sent to the network function directly or via the network slice orchestrator.

41. The network slice certificate orchestrator of claim 38, wherein the signed certificate is sent to the network function directly or via the network slice orchestrator.

42. The network slice certificate orchestrator of claim 39, wherein the signed certificate is sent to the network function directly or via the network slice orchestrator.

43. A management system comprising:
at least one processor; and
at least one memory storing instructions that, when executed by the at least one processor, cause the management system at least to:
establish a secure connection with a network slice certificate orchestrator; and
transmit to the network slice certificate orchestrator, certification authority configuration indicative of a certification authority configured for one or more network slices.

44. The management system of claim 43, wherein the certification authority configuration comprises at least one of:
a list of the one or more network slices;
an internet protocol address or uniform resource locator of the certification authority configured for the one or more network slices;
information of a domain name system server configured to resolve the uniform resource locator of the certification authority; or
usage of the certification authority.

45. The management system of claim 44, wherein the usage of the certification authority indicates whether the certification authority is a root certification authority or a subordinate certification authority for the one or more network slices.
